(19) United States
(12) Patent Application Publication
(10) Pub. No.: US 2003/0058853 A1
(43) Pub. Date: Mar. 27, 2003

(54) Method and apparatus for mobile device roaming in wireless local area network

(76) Inventors: Eugene Gorbatov, Hillsboro, OR (US); Juan Rivero, Beaverton, OR (US)

Correspondence Address: Pillsbury Winthrop LLP, Intellectual Property Group, Suite 2800, 725 S. Figueroa Street, Los Angeles, CA, 90017-5406, US

(21) Appl. No.: 09/963,869

(22) Filed: Sep. 26, 2001

(51) Int. Cl. H04L 12/28

(52) U.S. Cl. 370/389; 370/352

(57) ABSTRACT

A wireless local area network system includes a network address translation (NAT) router coupled to a public network. The NAT router is adapted to assign a private address to a mobile wireless device and to assign a global address for communications to the public network. A plurality of access points is provided, each of the access points being in communication with the network address translation (NAT) router. The access points are adapted to provide wireless communications with the mobile wireless device. The mobile wireless device communicates with at least one of the access points at a time. Data for the mobile wireless device is broadcast to all of the access points. Recently-received data is buffered at one or more of the access points adjacent to the at least one access point currently in communication with the mobile wireless device.

### BACKGROUND OF THE INVENTION

1. Field of the Invention

The present invention generally relates to mobile wireless communications. More particularly, the present invention relates to application-level roaming in a wireless local area network (LAN), such as an Institute of Electrical and Electronics Engineers (IEEE) 802.11 Standard wireless local area network.

2. Discussion of the Related Art

In recent years, wireless communication has encountered tremendous growth. Wireless technology is being accepted more greatly each day by people in their everyday lives. Wireless technology is at a point where it could be utilized virtually anywhere on the planet. Millions of people each day exchange information using pagers, cellular telephones, and other wireless communication devices. With the great success of wireless telephony and messaging services, wireless communication is being more accepted in personal and business computing. Wireless communication for computer applications allows users to be untethered from wired networks and to allow them to access and share information anywhere and on the move.

The IEEE 802.11 Standard entitled, “IEEE Standard for Wireless LAN Medium Access Control (MAC) and Physical Layer (PHY) Specifications” defines over-the-air protocols necessary to support networking in local area networks. As with other IEEE 802-based Standards, such as the 802.3 Standard and the 802.5 Standard, the primary purpose of the 802.11 Standard is to deliver MAC Service Data Units (MSDUs) between peer Logical Link Controls (LLCs). In other words, the 802.11 Standard enables a mobile wireless client, (such as portable laptop computers, personal digital assistants (PDAs), cellular telephones, etc.) to interface “over the air” utilizing, for example, radio frequency (RF) or infrared (IR) light signals, with a local area network via a base station or access point, or with other mobile wireless clients. Under the 802.11 Standard, the RF signals preferably operate in the 2.4 gigahertz (GHz) band range.

The IEEE 802.11 Standard provides MAC and PHY functionality for wireless connectivity of fixed, portable, and mobile/moving stations at pedestrian and vehicle speeds within a local area. The 802.11 Standard has the following characteristics: (1) support of asynchronous and time-bounded delivery service; (2) continuity of service within extended areas via a distribution system, such as an Ethernet; (3) accommodation of transmission rates of one and two megabits-per-second (Mbps); (4) multicasting and broadcasting services; (5) support of market applications; (6) network management services; and (7) registration and authentication services. Other IEEE 802.11 variants, such as the 802.11b standard, for example, has transmission rates of 5.5 to 11 Mbps, while the 802.11a standard, for example, supports a 54 Mbps transmission rate and operates in the 5 GHz range. The IEEE 802.11 Standard is ideal for wireless local area networking applications for use inside buildings, such as offices, banks, malls, shops, industrial plants or factories, hospitals, and homes/residences. However, outdoor areas, such as parking lots, campuses, parks, etc., are also suitable for use.

Many wireless applications executing on mobile wireless clients require continuous network connectivity. As a mobile wireless client moves from one attachment/access point in a network to another, support for seamless connectivity becomes an important concern. For example, a Web browser preferably has transparent access to the underlying wireless network as the user moves from one subnet to another. Current solutions require changes in the global Internet protocol infrastructure at either the Internet Protocol (IP) or transport layers. The deployment of these solutions is slow, thus many wireless applications today have limited support for roaming. Moreover, these mobile protocols provide solutions for a general problem of mobility where a device roams between various dissociated private and public networks, and where a device can act as both a client and a server. While achieving transparent access to the network, these mobile protocols introduce complexity, require a global change in Internet protocol implementation, and may exhibit performance degradation, especially due to security implementations.

Accordingly, there is a need for a mobile wireless networking system that does not require a change in the networking infrastructure, does not depend on global implementation, and is based on existing and well-understood Internet protocols and standards.

### BRIEF DESCRIPTION OF THE DRAWINGS

FIG. 1 illustrates a wireless local area network system according to an embodiment of the present invention; and

FIG. 2 illustrates a flow chart diagram of operating a wireless local area network according to an embodiment of the present invention.

### DETAILED DESCRIPTION

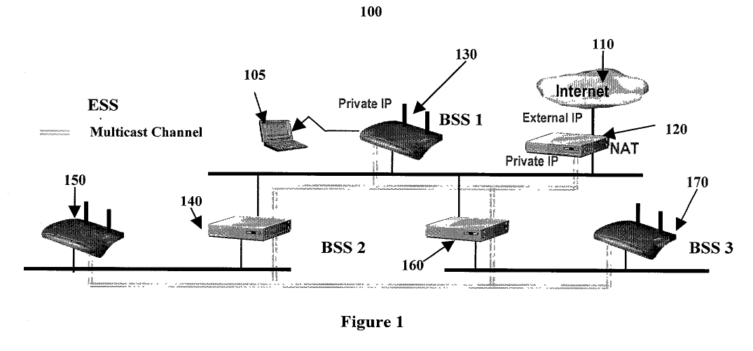

FIG. 1 illustrates a wireless local area network system according to an embodiment of the present invention. The wireless local area network (LAN) system 100 includes a network address translation (NAT) router 120 having a connection to an external or public network, such as the Internet 110. The NAT router 120 is preferably an IP router. The NAT router 120 is adapted to assign a private address, such as a private Internet Protocol (IP) address, to a mobile wireless device 105, as well as to other devices, such as other routers 140, 160, within the wireless LAN system 100. The NAT router 120 may be formed of one or more router devices.

A router (preferably including a network bridge) 120, 140, 160 and a corresponding access point 130, 150, 170 each make up a basic service set (BSS). An access point 130, 150, 170 forms a bridge between the wireless and wired local area networks. Access points 130, 150, 170 are analogous to base-stations of cellular telephone networks. Therefore, access points 130, 150, 170 are generally radio-frequency (RF) transceivers or infrared transceivers that connect to the wired network via, for example, an Ethernet port. The radio-frequency access points 130, 150, 170 preferably operate in the 2.4 GHz band range, utilizing, for example, Direct Sequence Spread Spectrum (DSSS), or Frequency Hopping Spread Spectrum (FHSS). However, any suitable frequency range and transmission scheme may be utilized.

Typically, all communications between a mobile wireless device 105 and a wired network client, or between mobile wireless devices, go through the access points 130, 150, 170. Access points 130, 150, 170 are generally not mobile, and they form part of the wired network infrastructure. Two or more basic service sets (BSSs) make up an extended service set (ESS) of the wireless LAN system 100. Access points 130, 150, 170 on average have broadcast ranges of approximately 100 to 500 meters, but, other suitable configurations and distances may be utilized, as well as other wireless protocol standards.

The private address assigned by the NAT router 120 is for use within the extended service set (ESS) of the local network. This private address is unique within the extended service set (ESS) and is not visible globally. For communication within the extended service set (ESS), the devices may utilize private addresses. For external communication (e.g., with the Internet 110), the NAT router 120 connecting the extended service set (ESS) to the public network 110 performs network address translation to assign global addresses, such as public IP addresses, to all of the connections going outside of the extended service set (ESS). The network address assigned to the mobile wireless device 105 preferably remains the same as the device 105 roams from one point of attachment to another (i.e., from one access point to another access point). Accordingly, the network is adapted to locate a particular mobile wireless device 105 and forward data addressed to its IP address.

In one embodiment of the present invention, all access points 130, 150, 170 connected to the extended service set (ESS) form a single multicast group. According to another embodiment of the present invention, only access points that are readily communicable with a mobile wireless device 105 form the multicast group. In the second embodiment, the multicast group dynamically changes, but always contains all of the access points with which the mobile wireless device 105 can readily interface. External routers treat private addresses as multicast addresses. When a mobile wireless device 105 initiates a new connection, an external router assigns it a new globally unique address and creates an entry in its NAT table. All the data addressed to this global address is translated to the corresponding private address and broadcasted to all access points 130, 150, 170. The access point 130, 150, 170 that currently connects the mobile wireless device 105 to the network forwards the data to the mobile wireless device 105.

Because a private address is independent of the public network 110 and does not change as the mobile wireless device 105 roams around the network, it does not matter to which access point 130, 150, 170 the mobile wireless device 105 is connected. Mobility is hidden from applications, and network connectivity is transparent and seamless as the mobile wireless devices 105 moves from one access point to another.

Data (e.g., in the form of data packets) for the mobile wireless device 105 is broadcast to all of the access points 130, 150, 170 within the wireless network system 100, even though the mobile wireless device 105 preferably communicates with only one access point 130, 150, 170 at a time. Broadcasting data to all of the access points 130, 150, 170 consumes additional bandwidth in the infrastructure network. To alleviate the burden on the network, the mobile wireless device 105 preferably includes an option to turn the roaming capability off. With roaming turned off, the mobile wireless device 105 acquires a new global address. Data destined for this mobile wireless device 105 is not broadcast to all of the access points 130, 150, 170, but rather follows a regular routing mechanism to the access point to which the mobile wireless device 105 is currently attached. An example of this mobile wireless device 105 may be a laptop computer connected to the wireless LAN.

When a mobile wireless device 105 moves from one access point 130, 150, 170 to another, data may be lost. To recover lost data, these mobile wireless devices 105 may request the data back from the server. The recovery of lost data increases the latency of the request and degrades the perceived performance. Accordingly, to minimize the latency, recently-received data is buffered at access points 130, 150, 170 adjacent to the access point currently in communication with the mobile wireless device 105. As the mobile wireless device 105 changes the point of attachment (i.e., access points 130, 150, 170), data that was lost while “in flight” becomes available at the new access point 130, 150, 170. The access points 130, 150, 170 may also advertise to the mobile wireless device 105 the data packets that it has buffered. If the mobile wireless device 105 determines that any of the data packets are missing, it may request them from the access point 130, 150, 170 without having to wait for the server to retransmit the data.

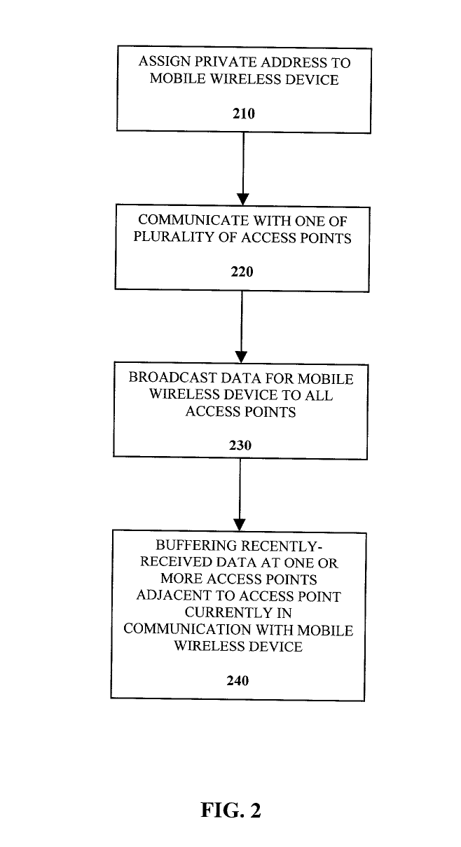

FIG. 2 illustrates a flow chart diagram of operating a wireless local area network according to an embodiment of the present invention. The NAT router 120 assigns 210 a private address to the mobile wireless device 105 and any other devices within the extended service set (ESS) of the wireless LAN system 100. The mobile wireless devices 105 are assigned multicast IP addresses, and the access points form the multicast group(s). The mobile wireless device 105 preferably communicates 220 with one of the plurality of access points 130, 150, 170 at a time. However, it is possible in an alternative embodiment and utilizing a suitable protocol, that the mobile wireless device 105 could communicate with one or more access points 130, 150, 170 at a time, especially when the mobile wireless device 105 transitions “in between” two access points so that it communicates with both of them. Data for the mobile wireless device 105 is broadcast 230 to all of the access points 130, 150, 170 within the extended service set (ESS). Recently-received data that is received by the access points 130, 150, 170 is buffered at one or more access points 130, 150, 170 adjacent to the access point currently in communication with the mobile wireless device 105. As the mobile wireless device 105 roams from one access point 130, 150, 170 to another, its address remains the same.

The wireless local area network system according to an embodiment of the present invention provides mobile wireless clients with roaming capability within an extended service set (ESS) of a wireless local area network, such as an IEEE 802.11 Standard local area network. This roaming capability is a valuable feature that enables transparent and seamless network connectivity for mobile devices.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A wireless local area network system, comprising:
a network address translation (NAT) router coupled to a public network adapted to assign a private address to a mobile wireless device and to assign a global address for communications to the public network; and
a plurality of access points in communication with the NAT router, the access points adapted to provide wireless communications with the mobile wireless device,
wherein the mobile wireless device communicates with at least one of the access points at a time, data for the mobile wireless device is broadcast to all of the access points, and recently-received data is buffered at one or more of the access points adjacent to the at least one access point currently in communication with the mobile wireless device.

2. The system according to claim 1, further including a server to receive data from and transmit data to the plurality of access points.

3. The system according to claim 1, further including a plurality of routers, wherein a router is associated with each one of the plurality of access points to route data therebetween.

4. The system according to claim 1, wherein the private address is a private Internet Protocol (IP) address.

5. The system according to claim 1, wherein the global address is a global Internet Protocol (IP) address.

6. The system according to claim 1, wherein the access points utilize Direct Sequence Spread Spectrum (DSSS).

7. The system according to claim 1, wherein the access points utilize Frequency Hopping Spread Spectrum (FHSS).

8. The system according to claim 1, wherein the public network is an Internet.

9. A wireless local area network system, comprising:
a mobile wireless device;
a network address translation (NAT) router coupled to a public network to assign a private address to the mobile wireless device and to assign a global address for communications to the public network;
a plurality of access points in communication with the NAT router, the access points adapted to provide wireless communications with the mobile wireless device,
wherein the mobile wireless device communicates with at least one of the access points at a time, data for the mobile wireless device is broadcast to all of the access points, and recently-received data is buffered at one or more of the access points adjacent to the at least one access point currently in communication with the mobile wireless device.

10. The system according to claim 9, further including a server to receive data from and transmit data to the plurality of access points.

11. The system according to claim 9, further including a plurality of routers, wherein a router is associated to each one of the plurality of access points to route data therebetween.

12. The system according to claim 9, wherein the private address is a private Internet Protocol (IP) address.

13. The system according to claim 9, wherein the global address is a global Internet Protocol (IP) address.

14. The system according to claim 9, wherein the access points utilize Direct Sequence Spread Spectrum (DSSS).

15. The system according to claim 9, wherein the access points utilize Frequency Hopping Spread Spectrum (FHSS).

16. The system according to claim 9, wherein the public network is an Internet.

17. A method of wireless local area network communication, comprising:
assigning a private address to a mobile wireless device;
communicating with at least one of a plurality of access points at a time;
broadcasting data for the mobile wireless device to all of the access points; and
buffering recently-received data at one or more of the access points adjacent to the at least one access point currently in communication with the mobile wireless device.

18. The method according to claim 17, further including receiving data and transmitting data to the plurality of access points.

19. The method according to claim 17, wherein the private address is a private Internet Protocol (IP) address.

20. The method according to claim 17, further including assigning a global address for communications to a public network.

21. The method of claim 20, wherein the public network is an Internet.

22. The method of claim 20, wherein the global address is a global Internet Protocol (IP) address.

23. The method according to claim 17, wherein the access points utilize Direct Sequence Spread Spectrum (DSSS).

24. The method according to claim 17, wherein the access points utilize Frequency Hopping Spread Spectrum (FHSS).

25. An access point for wireless local area network communication with a mobile wireless device, comprising:
a machine-readable storage medium; and
machine-readable program code, stored on the machine-readable storage medium, having instructions to
transmit a private address to the mobile wireless device assigned by a network address translation (NAT) router,
communicate wirelessly with the mobile wireless device, wherein the mobile wireless device communicates with at least one of a plurality of access points at a time, and data for the mobile wireless device is broadcast to all of the access points, and
buffering recently-received data if the access point is adjacent to the at least one of the plurality of access points currently in communication with the mobile wireless device.

26. The access point according to claim 25, wherein the machine-readable program code further includes instructions to receive data from and transmit data to a server.

27. The access point according to claim 25, wherein the private address is a private Internet Protocol (IP) address.

28. The access point according to claim 25, wherein the access point utilizes Direct Sequence Spread Spectrum (DSSS).

29. The access point according to claim 25, wherein the access point utilizes Frequency Hopping Spread Spectrum (FHSS).
